(19) United States
(12) Patent Application Publication
(10) Pub. No.: US 2005/0105573 A1
(43) Pub. Date: May 19, 2005

(54) Driver circuit for a semiconductor laser diode with a short time constant of the feedback loop

(76) Inventors: Shigeo Hayashi, Yokohama-shi (JP); Takashi Fukuoka, Yokohama-shi (JP)

Correspondence Address: MCDERMOTT WILL & EMERY LLP, 600 13th Street, N.W., Washington, DC, 20005-3096, US

(21) Appl. No.: 10/954,347

(22) Filed: Oct. 1, 2004

(30) Foreign Application Priority Data
Oct. 2, 2003 (JP) 2003-344681

(51) Int. Cl. H01S 3/00

(52) U.S. Cl. 372/38.01; 372/38.02

(57) ABSTRACT

The present invention is to provide a laser driving circuit having a comparably short time constant, accordingly, can follow fluctuations with a short time interval. The circuit of the present invention provides a feedback transistor in addition to a driver transistor for driving the laser diode and a photodiode for detecting a portion of the optical output of the laser diode. The feedback transistor controls, by receiving the information derived from the photo current generated in the photodiode, the current flowing in the driver transistor and the laser diode. The time constant of the feedback loop, i.e., the laser diode, the photodiode, the feedback transistor, the driver transistor and the laser diode, is far smaller than that of the APC loop. Therefore, the feedback control for the short time constant phenomena may be carried out.

### BACKGROUND OF THE INVENTION

1. Field of the Invention

The present invention relates to a driver circuit for driving a laser diode, in particular, the driver circuit includes a driving transistor connected in parallel or in series to the laser diode, and a photodiode for receiving a portion of light emitted from the laser diode.

2. Related Prior Art

To operate a semiconductor laser diode (hereinafter denoted as LD), a modulation current Is and a bias current Ib are provided thereto. FIG. 17 shows a relation of the modulation and bias currents to an optical output of the LD. When the current supplied to the LD is below a threshold current Ith thereof, the LD emits light in an LED mode and an optical output thereof is fairly small. Once the current supplied thereto exceeds the threshold current Ith, the LD emits light in an LD mode, in which the optical output abruptly increases as the current increase.

Generally, the LD mode and the LED mode may be distinguished whether the light emitted therefrom is in coherent or in in-coherent. The bias current Ib is typically set to be a value slightly larger than the threshold current Ith, and the modulation current Is superposed on the bias current generates an optical signal. The threshold current Ith, as shown in FIG. 17, has large temperature dependence such that it changes from Ith to Ith′ as the temperature increases, which affects the average optical output and an extinction ratio thereof

Various methods for controlling the optical output of the LD have been disclosed, and an APC (Auto Power Control) method is well known in the field. The APC is a method that, a portion of the optical output from the LD is detected by a photodiode, the current supplied to the LD is adjusted so as to maintain the optical output power and the extinction ratio thereof The LD has two cleaved surfaces, one of which has a low reflective film with a few percent thereon, and the other of which has a high reflective film over 90%. Between these two cleaved surfaces is provided an optical resonator and coherent light may be obtained having a longitudinal mode determined by the length between the surfaces. Even the back surface having a high reflective film does not show 100% reflection, so the faint portion of light may be leaked therefrom. In the APC, the leaked light is detected by the photodiode and, based on thus monitored light, the optical output power from the LD can be controlled.

Various APC circuits are proposed. For example, as shown in FIG. 18, the Japanese patent published as S59-112670 have been disclosed that both an average optical output power and a peak power corresponding to a logical high level are detected by an average detecting block 14 and a peak detecting block 15, respectively. Thus detected average and peak power are fed back to the modulation current Is and the bias current Ib for the LD.

In the APC circuit shown in FIG. 18, an input signal Vs and a reference bias Vb are added to the modulation current Is from one driver block 11 and to the bias current Ib from the other driver block 12. The adder 23 superposes thus added input signal Vs and the reference bias Vb, and supplied the superposed signal Vs and Vb to the LD 13. The LD emits coherent light P when the supplied current thereto exceeds the threshold level. The PD 20 receives the back facet light of the LD 13, and generates the photo current corresponding to the output optical power P of the LD 13. The average detecting block 14 obtains an average optical power while the peak detecting block 15 obtains a peak optical power. The average power and the peak power are, after amplified at respective amplifier 16 and 17, compared to reference values Ss and Sb, and the results of the comparison are fed to respective drivers 11 and 12. Thus configured APC circuit adjusts the optical output from the LD 13 such that the average power coincides with the reference value Ss and the peak power thereof coincides with the other reference value Sb.

Another Japanese patent published as H10-144986 has disclosed a modified method for controlling the optical output of the LD, in which two optical output levels Pk(L) and Pk(H), one corresponding to a logical “0” while the other corresponding to a logical “1”, are detected. The modulation current of the LD is adjusted such that the peak optical power from the LD is maintained by comparing the Pk(H) with a reference value, while the bias current is controlled to keep the difference Pk(H)−Pk(L) constant.

Still another Japanese patent published as H09-092916 has disclosed a method that the average and the peak power corresponding to a logical “1” are detected and thus detected values are fed back to the bias and modulation current of the LD. In this patent, the feedback of the detected optical power is carried out by taking the temperature characteristic of the LD into account.

In order to detect the average power, some integrating circuits must be configured in the APC circuit. Therefore, the APC circuit can not follow the fluctuations shorter than the time constant of the integrating circuit. For example, the LD controlled by the APC circuit can not follow the burst signal.

Regarding to the peak detecting, a general peak detecting circuit configures a smoothing circuit using a diode, namely, configures a peak hold circuit. The peak hold circuit is one type of the integrating circuit, accordingly, can not follow the transition shorter than the time constant attributing to the peak hold circuit.

On the other hand, although the LD, in principle, follows the input signal in bit to bit mode, the optical status thereof may change within one bit. When a signal with a long period, for example, a logical “1” state continues for dozens of or hundreds of bit but far shorter than the time constant of the APC circuit, it is known that the optical output from the LD gradually decreases from the beginning. This is due to the self-heating phenomenon that the temperature of the LD itself rises due to the current supplied thereto and the optical efficiency reduces. The time constant of this phenomenon is from a few microseconds to a few milliseconds, far shorter than the time constant of the average detecting or the peak detecting circuit.

Thus, the LD can be feedback controlled for the bias and the modulation current thereof by the APC circuit. However, since this feedback control is substantially DC feedback using the average or the peak detecting, the time constant of the feedback loop is comparatively longer.

### SUMMARY OF THE INVENTION

Therefore, one object of the present invention is to provide a driver circuit for the laser diode, in which the time constant of the feedback control loop is comparatively short and may follow the fluctuation with a short time constant.

According to one aspect of the present invention, A driver circuit for a semiconductor laser diode is provided. The driver circuit includes a semiconductor laser diode, a driver transistor, a photodiode and a feedback transistor. The driver transistor is connected in parallel or in series to the laser diode. The photodiode receives a portion of light emitted from the laser diode. The feedback transistor is connected in parallel or in series to the laser diode or to the driver transistor. Thus, a current flowing in the feedback transistor, which is adjusted by a photo current generated in the photodiode, controls a current flowing the driver transistor.

Another aspect of the present invention, a driver circuit that includes an amplifier for driving the driver transistor instead of the feedback transistor. The photo current generated in the photodiode controls an input of the amplifier such that the optical output of the laser diode, which is driven by the driver transistor, is kept constant.

According to the present driver circuit for the laser diode, since no substantial capacitor is included in the feedback loop for the control of the optical output of the laser diode, the time constant of the feedback loop may be shortened. Accordingly, a feedback control in a bit-to-bit mode may be realized, whereby a gradual reduction of the optical output from the laser diode due to the self-heating phenomena may be compensated.

### BRIEF DESCRIPTION OF DRAWINGS

FIG. 1 is a view showing a mechanism of the feedback control according to the present invention;

FIG. 2 shows a modification of the fundamental circuit shown in FIG. 1;

FIG. 3 shows another modification of the fundamental circuit shown in FIG. 1;

FIG. 4 shows still another modification of the fundamental circuit shown in FIG. 1;

From FIG. 5A to FIG. 6B show driver circuits using a differential amplifier for controlling in feedback the optical output of the laser diode in the series drive mode;

FIG. 7A and FIG. 7B show circuits where the feedback transistor is connected in parallel to the laser diode and the driver, they are connected in series, in the series drive mode;

FIG. 8A and FIG. 8B show circuits where the feedback transistor is connected in parallel only to the laser diode in the series drive mode;

FIG. 9A and FIG. 9B show circuits where the feedback transistor is connected in parallel only to the driver transistor;

From FIG. 9C to FIG. 9E show circuits where the feedback is provided to the power supply of the laser diode in the series drive mode;

From FIG. 10A to FIG. 10C show circuit in the series drive mode, where the feedback is provided to the laser diode or to both of the laser diode and the driver transistor;

From FIG. 11A to FIG. 12 show circuit in the shunt drive mode, where the feedback is provided to the amplifier;

From FIG. 13A to FIG. 13C show circuits in the shunt drive mode, where the feedback is provided to the power supply;

FIG. 14A and FIG. 14B show circuits in the shunt drive mode, where the feedback is provided only to the laser diode;

FIG. 15A and FIG. 15B show circuits in the shunt drive mode, where the feedback is provided to the power supply for the laser diode;

FIG. 16A and FIG. 16B show circuits in the shunt drive mode, where the feedback is provided only to the laser diode;

FIG. 17 is a view showing an operation of the laser diode under various temperatures; and

FIG. 18 is a block diagram showing a conventional APC circuit.

### DETAILED DESCRIPTION OF PREFERRED EMBODIMENTS

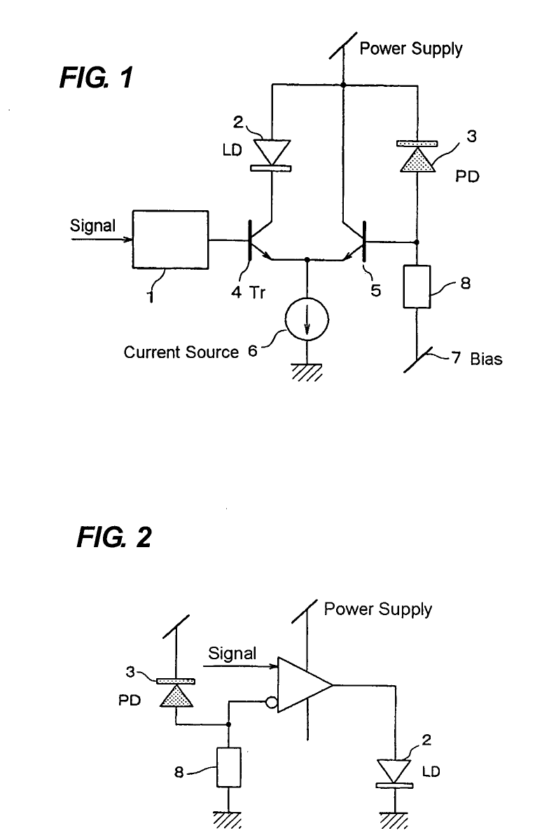

An outline of a laser driving circuit according to the present invention will be described as referring to figures from FIG. 1 to FIG. 4. FIG. 1 is a circuit diagram showing a first basic configuration, figures from FIG. 2 to FIG. 4 show modifications of FIG. 1.

In FIG. 1, a signal is inputted into a LD-driver 1, an output of which drives a differential circuit configured by a driver transistor Tr 4 and a feedback transistor Tr 5. The LD 2 is connected to the collector of the Tr 4 as a load thereof, while the base of the feedback transistor Tr 5 is biased by a photodiode PD 3 and a resistor connected in serial to the photodiode PD 3. The common emitter of the Tr 4 and Tr 5 is connected to a constant current source 6. Although not shown in FIG. 1, the PD 3 is arranged such that the PD 3 may receive light emitted from a back facet of the LD2.

The signal is led to the Tr 4 after processing in the LD driver 1 such that the magnitude and the level thereof are adjusted to drive the transistor Tr 4. When the logical “H” level of the signal is inputted into the Tr 4, which turns on the transistor, a current decided by the current source 6 flows from the power supply through the LD 2 and the Tr 4, which emits light from the LD 2. A portion of the light emitted from the LD 2 may be received by the PD 3, which generates a photo current in the PD 2. The photo current from the PD 3 flows in the resistor 8, which increases the voltage drop at the resistor 8 and enhances the voltage level of the base of the Tr 5. Since the Tr 4 and the Tr 5 configures a differential circuit, and the sum of the current flowing respective transistors, Tr 4 and Tr 5, is decided by the constant current source 6, the current flowing the Tr 4 relatively decreases, accordingly the optical output power from the LD 2 reduces.

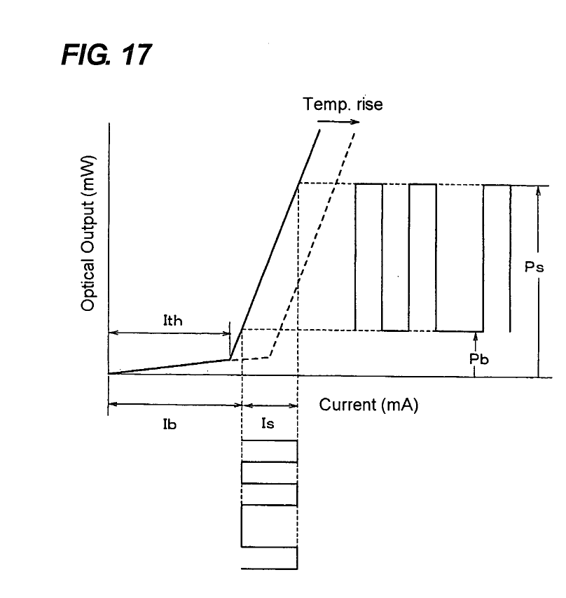

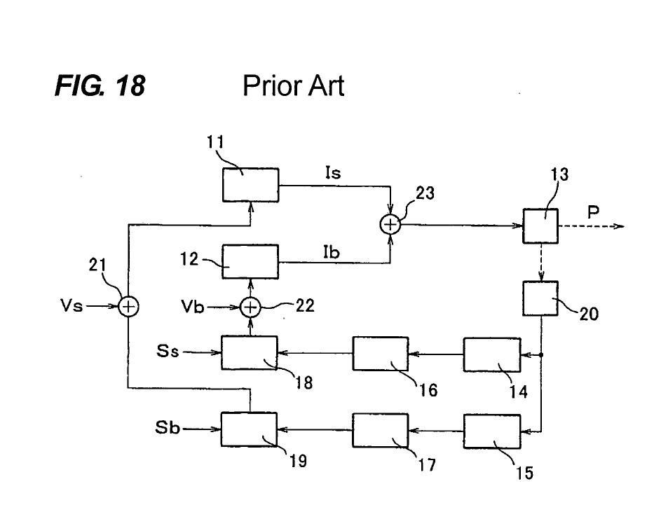

That is, a current feedback operates for the Tr 4 via the LD 2, PD 3, and Tr 5, which automatically defines an operating point of the bias condition for respective devices. Even when the operating condition becomes off from the stable point, the current feedback automatically operates and the circuit for driving the LD 2 automatically falls into the stable condition. For example, when the temperature of the LD 2 increases due to the current flowing therein, as shown in FIG. 17, the threshold current of the LD 2 increases and the optical output power thereof decreases. Due to the reduction of the optical output of the LD 2, the optical power received by the PD 3 decreases, the bias level of the Tr 5 lowers, and the current flowing the Tr 5 drops, which increases the current flowing the paired transistor Tr 4 and thus the optical output power of the LD 2.

The time constant of the feedback operation described above depends on devices including in the feedback loop. However, no substantial capacitor exists in the feedback loop, a prompt response may be expected. Using high speed devices that show small parasitic capacitance, the response within a few nanoseconds may be realized. In FIG. 1, the speed of the response is primary determined by the CR circuit configured by the resistor 8 and the junction capacitance of the PD 3. Setting the resistance of the resistor 8 is small enough, it may be possible to escape from the junction capacitance of the PD 3. However, the resistor 8, on the other hand, determines the bias level of the Tr 5. Therefore, using the resistor 8, whose resistance is quite small, the bias level of the Tr 5 may be set by using the external bias supply 7.

FIG. 2 replaces the differential circuit including a paired transistor, Tr 4 and T5, into a differential amplifier, and the mechanism of the current feedback is the same as those described in FIG. 1. That is, the LD 2 is driven by the signal input to the differential amplifier, and a photo current is generated in the PD 3 by the optical output from the LD 2. The photo current thus generated influences the voltage drop at the resistor 8, and consequently the output of the differential amplifier. This feedback loop automatically decides the operating condition of respective devices and sets the devices in stable state.

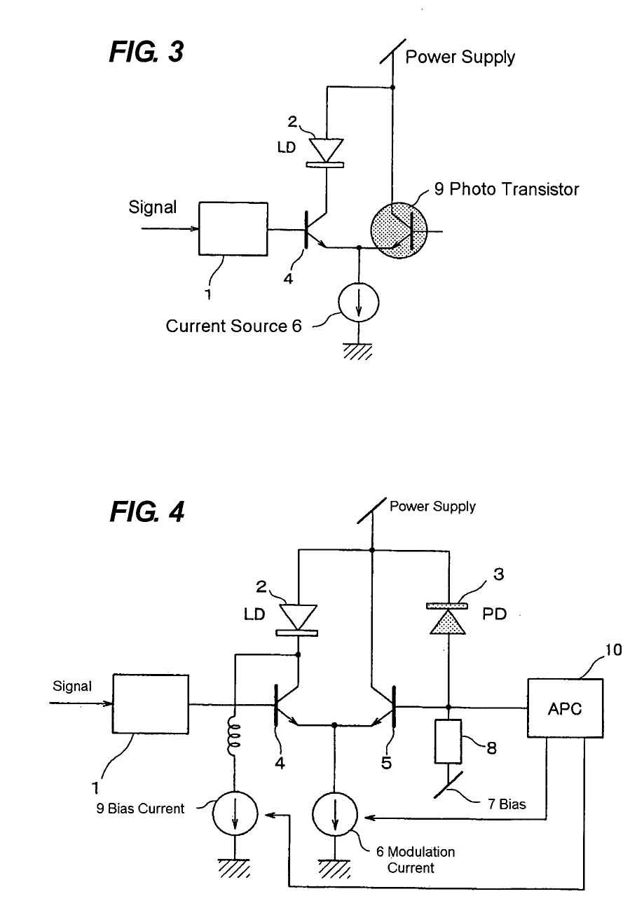

FIG. 3 replaces the transistor Tr 5 in FIG. 1 into a photo-transistor 9. That is, the PD 3 and the Tr 5 in FIG. 1 are replaced to one photo-transistor 9 in FIG. 3. In this circuit, the operating condition of the LD 2, i.e. the average output and the extinction ration thereof, is set by the LD driver 1, and the output of the LD driver 1 is led into the base of the Tr 4. When the Tr 4 is set to be “H” level, the current flows therein and the LD 2 emits light. A portion of the light emitted from the LD 2 is received by the photo-transistor 9, which increase the current flowing therethrough, and the other current flowing the Tr 4 decreases, thus the optical output power from the LD 2 also decreases.

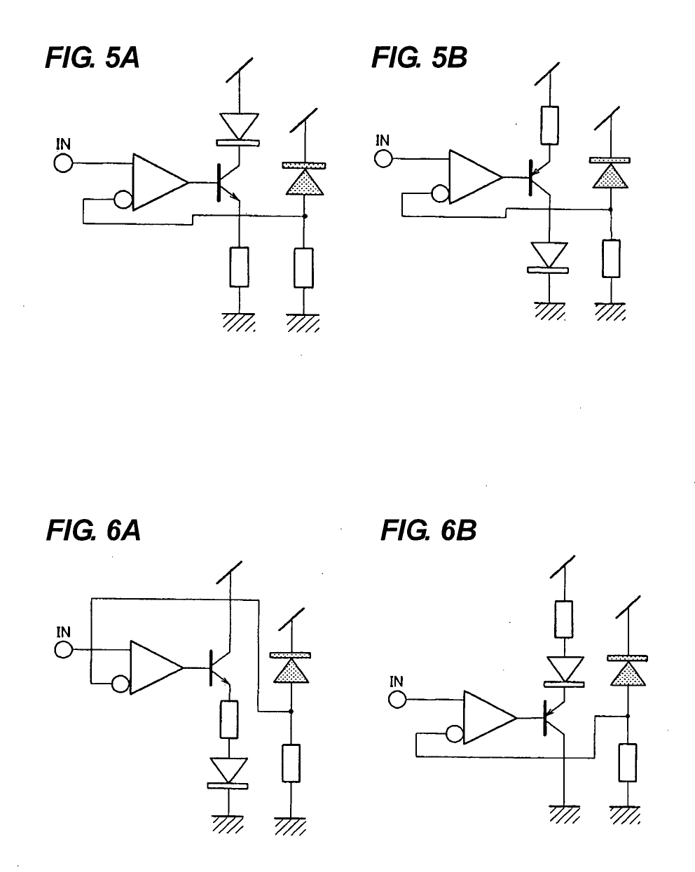

FIG. 4 adds an APC (Automatic Power Control) circuit to the basic configuration shown in FIG. 1. The output of the PD 3 is led to, not only to the resistor 8, but the APC 10. The bias current and the modulation current of the LD 2 are controlled by the APC 10. A time constant of the APC 10 is typically from a few millisecond to a few second, while the current feedback according to the present invention, which is carried out by the resistor 8 and the Tr 5, is merely from a few nanosecond to a few micro-second. These double feedback enables to stable the operation of the LD 2 both in a short period and in a long period.

Various modifications of the basic circuit shown in figures from FIG. 1 to FIG. 4 may be considered. Next, figures from FIG. 5 to FIG. 16 show such modifications. These circuits may be roughly classified into two categories, i.e. a series drive and a shunt drive. In the series drive, as shown in FIG. 5 to FIG. 10, a LD and a driver transistor are connected in series. The signal for driving the LD is input to the control terminal of the transistor, and turning on/off the transistor drives the LD. On the other hand, as shown in FIG. 11 to FIG. 16, the LD and the transistor for driving the LD are connected in parallel in the shunt drive. By inputting the signal into the control terminal of the transistor connected in parallel, the current flowing the LD is shunted from the LD to the transistor or from the transistor to the LD. Further, depending on the device to which the current feedback is performed from the PD, the driver circuit may be categorized as shown in the following table.

TABLE
Categorizing the driver circuit shown in figures

| | Feedback | Series Drive | Shunt Drive |
|---|---|---|---|
| (1) | LD | 8A, 8B, 10A | 14A, 14B, 16A, 16B |
| (2) | Driver Tr | 9A, 9B | |
| (3) | LD + Driver Tr | 7A, 7B, 10B, 10C | |
| (4) | Bias Supply | 9C, 9D, 9E | 13A, 13B, 13C, 15A, 15B |
| (5) | Signal | 5A, 5B, 6A, 6B | 11A, 11B, 12 |

(1) Feedback Only to the LD

Circuits categorized in this group has a current feedback only to the LD, i.e. between the collector and the emitted of the transistor connected in parallel to the LD functions as a bypass circuit for the current flowing the LD. By the current feedback only to this transistor, the optical output from the LD can be adjusted.

When the optical output reduces, the photo current generated by the photodiode decreases and the current flowing the transistor also reduces. Thus the current provided to the LD is relatively increased, which increases the optical output from the LD. On the other hand, when the optical output of the LD increases, an opposite feedback operation may be carried out by the photo diode and the feedback transistor.

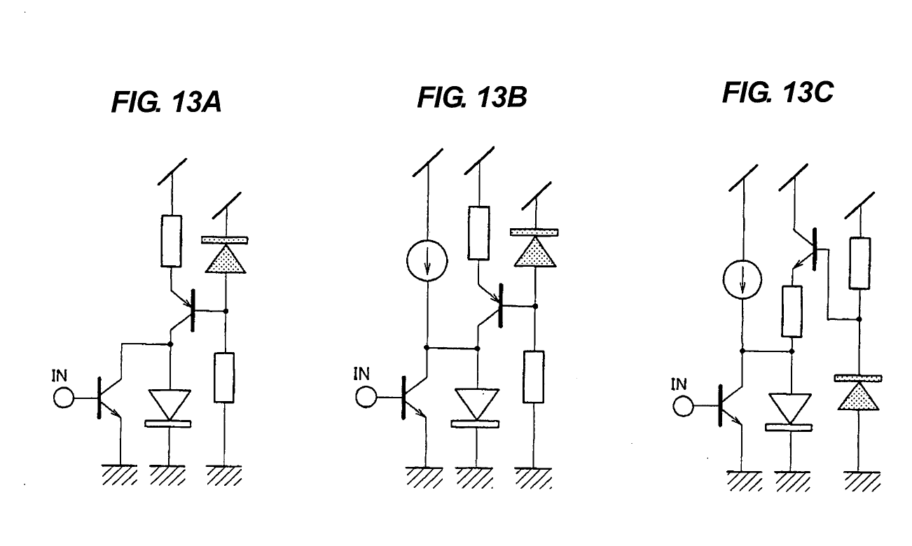

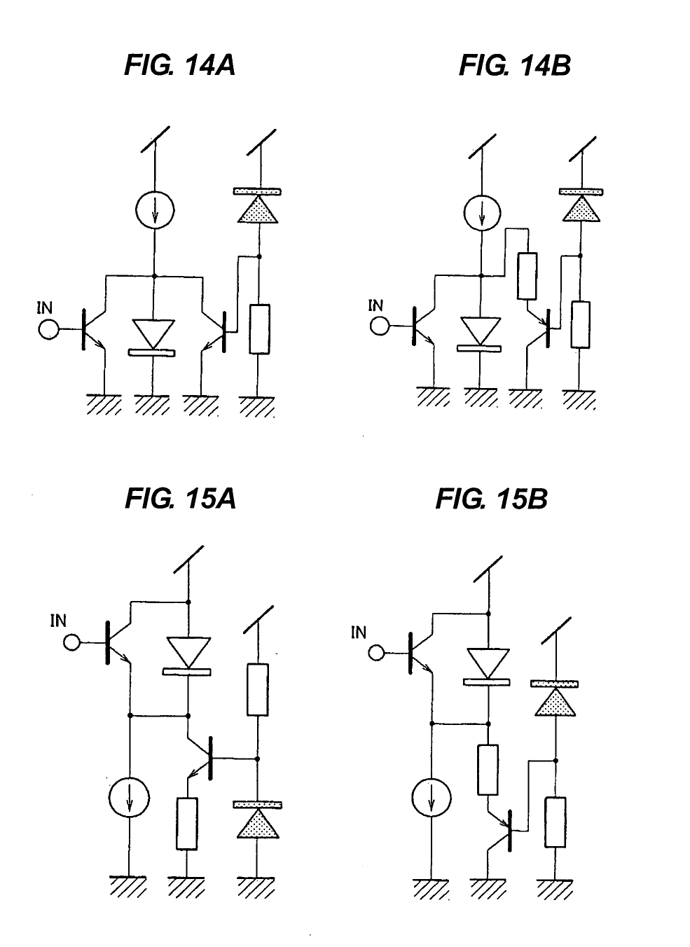

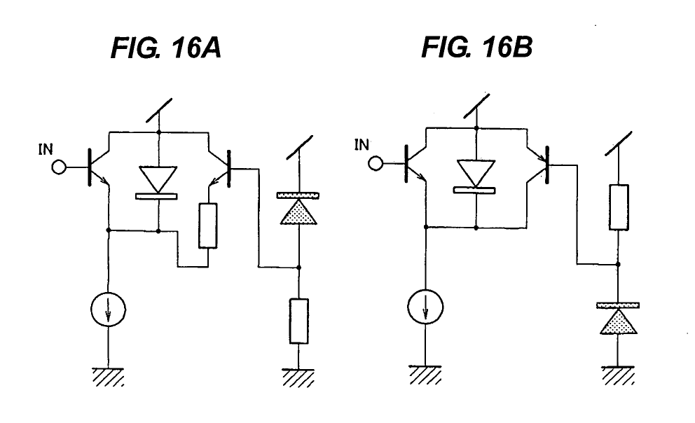

FIG. 8A and FIG. 8B are distinguished only by a type of the feedback transistor, namely, FIG. 8A corresponds to the pnp-type while FIG. 8B uses the npn-type transistor. Further, in FIG. 8A and FIG. 8B, the LD is connected to the collector of the driver transistor, which is called as a collector output, while in FIG. 10A, the LD is connected to the emitter of the transistor, which is called as an emitter output. FIG. 14A and FIG. 14B, both show shunt drive modes, distinguishes only by the type of the transistor, the former uses the npn-type while the other uses the pnp-type. The difference between FIG. 16A and FIG. 16B is also derived only from the type of the transistor. FIG. 14A and FIG. 14B show the collector output configuration, while FIG. 16A and FIG. 16B show the emitter output configuration.

(2) Feedback Only to the Driver Transistor

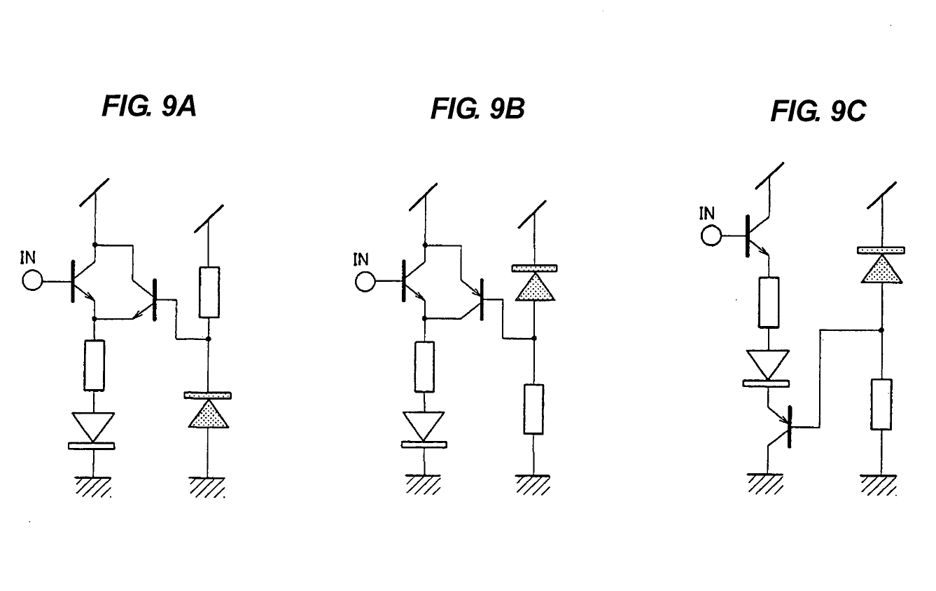

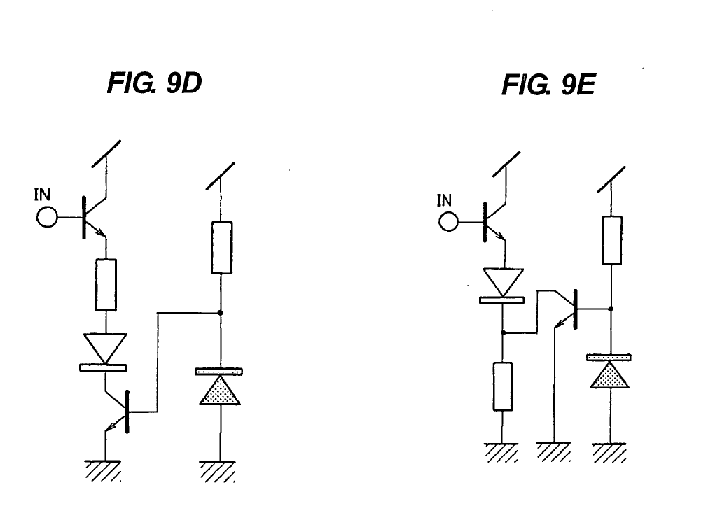

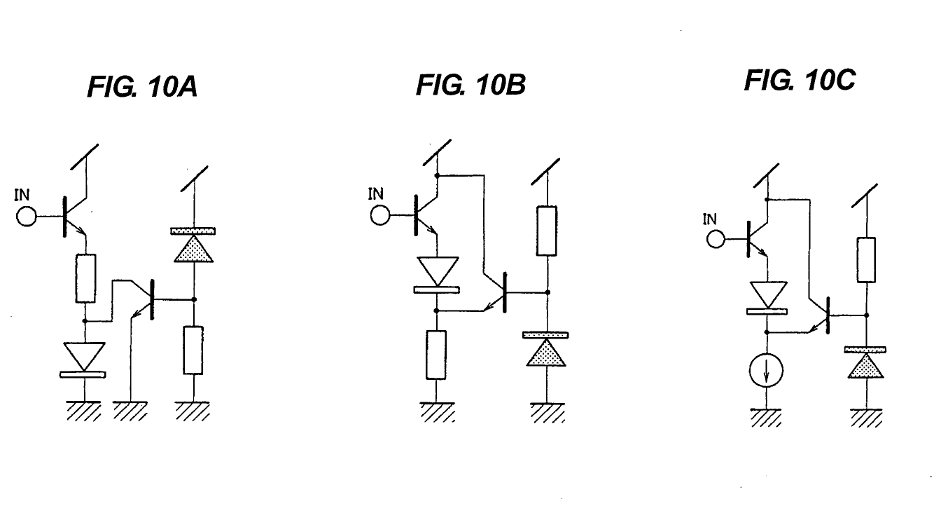

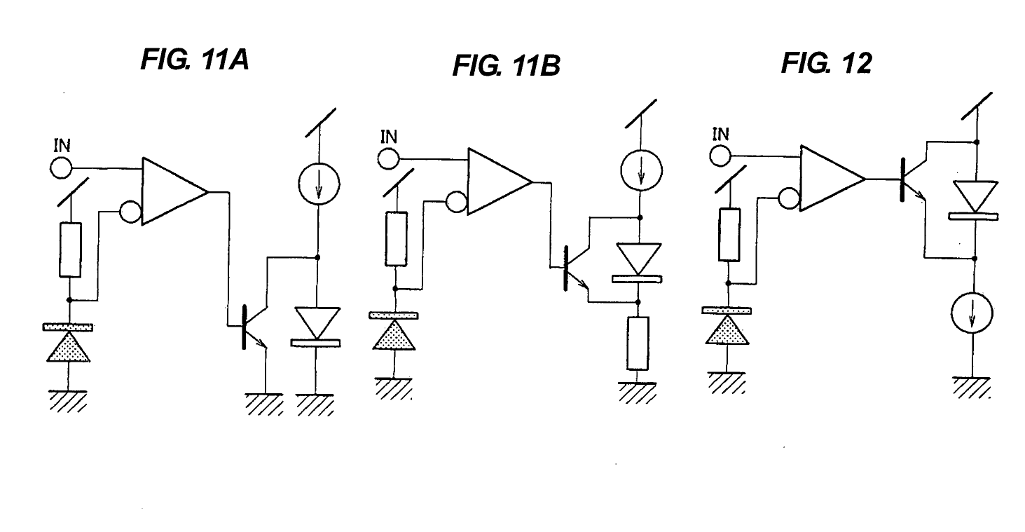

Configurations categorized in this group have a feedback transistor connected in parallel to the driver transistor. FIG. 9A and FIG. 9B, they have series drive mode, meet the requirements of this group. In the shunt drive mode, since the drive transistor is connected in parallel to the LD, the circuit will be categorized in the former group (1). The feedback transistor connected in parallel to the driver transistor may be regarded as a variable resistor. By changing the current flowing from the collector to the emitter of the feedback transistor, the current flowing in the driver transistor may be adjusted.

That is, when the optical output from the LD reduces, the photo current generated in the PD reduces and the current flowing the feedback transistor increases, which increases the current flowing the LD even if the current flowing the driver transistor is kept constant and the optical output from the LD enhances. On the other hand, when the optical output from the LD increases the current generated in the PD increases and the current flowing in the feedback transistor decreases, which reduces the current flowing the LD and the optical output thereof The difference between FIG. 9A and FIG. 9B is due to the type of the feedback transistor, the former for the pnp-type and the latter for the npn-type.

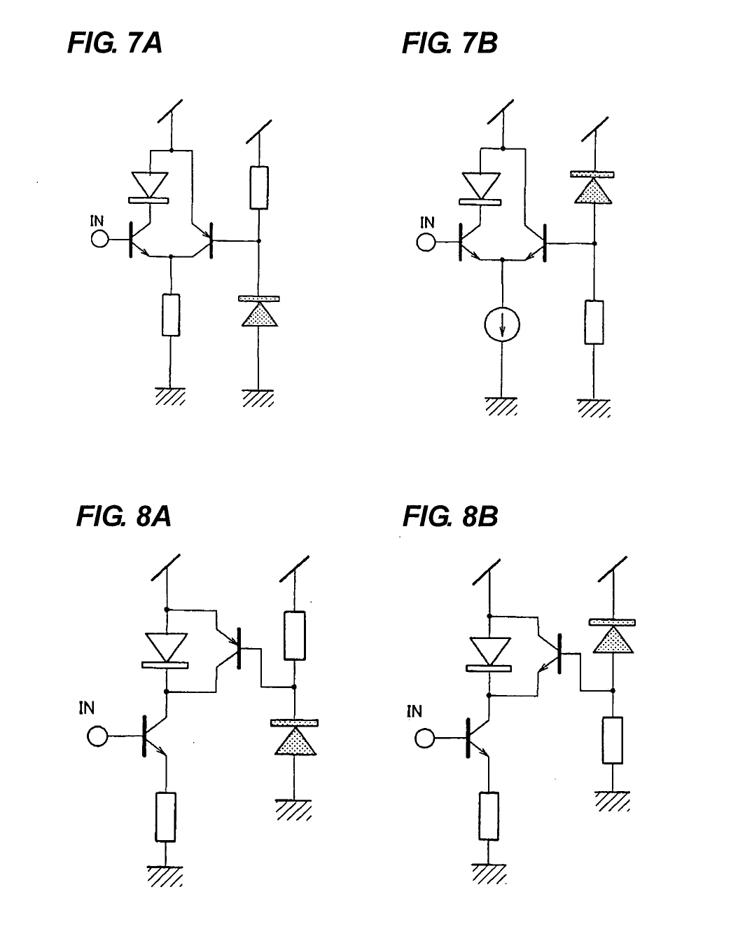

Circuits categorized in this group have the configuration of the feedback to the series circuit of the LD and the driver transistor, and FIG. 7A, FIG. 7B, FIG. 10B and FIG. 10C, they have the series drive mode, are involved in this group. In the shunt drive mode, the LD and the driver transistor are connected in parallel, so no circuits are categorized in this group. The fundamental configuration shown in FIG. 1 is included in this group, in which the LD and the driver transistor are connected in series, while the feedback transistor is connected in parallel to the driver transistor. Thus, by adjusting the current flowing in the feedback transistor, the current flowing in the driver transistor can be controlled, so do the current flowing in the LD.

When the optical output from the LD reduces, the photo current generated in the PD and the current flowing the feedback transistor also reduce. Decreasing the current flowing in the feedback transistor, the current flowing in the driver transistor and the LD oppositely increases, thereby enhancing the optical output from the LD. On the other hand, the optical output from the LD increases, the photo current in the PD, whereby the current flowing in the feedback transistor increase. Increasing the current flowing in the feedback transistor, the other current flowing in the driver transistor and the LD decreases, thereby reducing the optical output from the LD. The difference between FIG. 7A and FIG. 7B is due to only the type of the transistor used therein, and FIG. 10B and FIG. 10C are substantially the same configuration. Configurations in FIG. 7 have the collector output, while those in FIG. 10 have the emitter output.

(4) Feedback to the Power Supply

Circuits categorized in this group have the configuration of the feedback to the power supply, although they seem to have a similar configuration to the previous group (3). From FIG. 9C to FIG. 9E have the series drive mode, while from FIG. 13A to FIG. 13C, FIG. 15A and FIG. 15B have the shunt drive mode. In these circuits, the feedback transistor controls the current provided from the power supply to the LD. Although the time constant of the feedback loop in this category has comparably longer than that of the other categories, the feedback amount, which is equivalent to the loop gain, may be enhanced.

FIG. 9E has a feedback transistor connected in parallel to the load resistor of the power supply. The feedback transistor behaves as a type of a variable resistor, that is, the current flowing the resistor may be adjusted by the current flowing the feedback transistor, accordingly, the voltage drop at the resistor may be adjusted so as to maintain the optical output from the LD. In the shunt drive mode, FIG. 13 has the collector output, in which the current source is connected to the collector of the driver transistor, while FIG. 15 has the emitter output, where the current source is connected to the emitter of the driver transistor. FIG. 13B, FIG. 13C, FIG. 15A and FIG. 15B have the feedback transistor connected in parallel to the power supply, in which the current from the power supply and from the feedback transistor are superposed and supplied to the LD.

(5) Feedback to the Signal Source

Circuits categorized in this group have the feedback to the amplifier that transmits the input signal to the LD. FIG. 5A, FIG. 5B, FIG. 6A and FIG. 6B fall within this group for the series drive mode, while FIG. 11A, FIG. 11B and FIG. 12 are for the shunt drive mode. In these circuits, one of the input of the amplifier is for the input signal, and the other input of the amplifier is provided for the feedback control.

In the series drive mode, when the optical output from the LD reduces, the photo current generated in the PD decreases and the level of the feedback lowers, whereby the output of the differential amplifier rises and the current flowing the drive transistor increases. On the other hand, when the optical output from the LD increases, the photo current generated in the PD increases and the level of the feedback rises, whereby the output of the amplifier lowers and the current flowing the drive transistor decreases.

The difference between FIG. 5A and FIG. 5B, and that between FIG. 6A and FIG. 6B are due to only the type of the driver transistor. FIG. 5A and FIG. 5B have the collector output configuration where the LD is connected to the collector of the driver transistor, while FIG. 6A and FIG. 6B have the emitter output configuration where the LD is connected to the emitter of the driver transistor. On the other hand, FIG. 11A has the collector output configuration where the current source is connected to the collector of the driver transistor, while FIG. 12 has the emitter output configuration that includes the current source connected to the emitter of the transistor. FIG. 11B has both types of the output.

Thus, the present invention has been described as referring to accompanying drawings. Although, the description refers only bipolar transistors, it is explicitly obvious that field effect transistors will show the same function and the same result. Further, it should be understood that the present invention could be embodied in many other specific ways without departing from the spirit or scope of the invention. Therefore, the present examples and methods are to be considered as illustrative and not restrictive, and the invention is not to be limited to the details given herein, but may be modified within the scope of the appended claims.

1. A circuit for driving a semiconductor laser diode that emits light by supplying a current, comprising:
a driver transistor connected in series to said semiconductor laser diode;
a photodiode for receiving said light emitted from said semiconductor laser diode, said photodiode generating a photo current corresponding to said light received by said photodiode; and
a feedback transistor connected in parallel to said semiconductor laser diode,
wherein said feedback transistor controls said current supplied to said semiconductor laser diode by said photo current generated in said photodiode.

2. A circuit for driving a semiconductor laser diode that emits light by supplying a current, comprising:
a driver transistor connected in series to said semiconductor laser diode;
a photodiode for receiving said light emitted from said semiconductor laser diode, said photodiode generating a photo current corresponding to said light received by said photodiode; and
a feedback transistor connected in parallel to said semiconductor laser diode and said driver transistor,
wherein said feedback transistor controls said current supplied to said semiconductor laser diode by said photo current generated in said photodiode.

3. A circuit for driving a semiconductor laser diode that emits light by supplying a current, comprising:
a driver transistor connected in series to said semiconductor laser diode;
a photodiode for receiving said light emitted from said semiconductor laser diode, said photodiode generating a photo current corresponding to said light received by said photodiode; and
a feedback transistor connected in parallel to said driver transistor,
wherein said feedback transistor controls said current supplied to said semiconductor laser diode by said photo current generated in said photodiode.

4. A circuit for driving a semiconductor laser diode that emits light by supplying a current, comprising:
a driver transistor connected in series to said semiconductor laser diode;
a photodiode for receiving said light emitted from said semiconductor laser diode, said photodiode generating a photo current corresponding to said light received by said photodiode; and
a feedback transistor connected in series to said semiconductor laser diode and to said driver transistor,
wherein said feedback transistor controls said current supplied to said semiconductor laser diode by said photo current generated in said photodiode.

5. A circuit for driving a semiconductor laser diode that emits light by supplying a current, comprising:
a driver transistor connected in series to said semiconductor laser diode;
a photodiode for receiving said light emitted from said semiconductor laser diode, said photodiode generating a photo current corresponding to said light received by said photodiode; and
an amplifier for driving said driver transistor,
wherein said amplifier controls said current supplied to said semiconductor laser diode by said photo current generated in said photodiode.

6. A circuit for driving a semiconductor laser diode that emits light by supplying a current, comprising:
a driver transistor connected in parallel to said semiconductor laser diode;
a photodiode for receiving said light emitted from said semiconductor laser diode, said photodiode generating a photo current corresponding to said light received by said photodiode; and
a feedback transistor connected in parallel to said semiconductor laser diode and to said driver transistor,
wherein said feedback transistor controls said current supplied to said semiconductor laser diode by said photo current generated in said photodiode.

7. A circuit for driving a semiconductor laser diode that emits light by supplying a current, comprising:
a driver transistor connected in parallel to said semiconductor laser diode;
a photodiode for receiving said light emitted from said semiconductor laser diode, said photodiode generating a photo current corresponding to said light received by said photodiode; and
a feedback transistor connected in series to said semiconductor laser diode and to said driver transistor,
wherein said feedback transistor controls said current supplied to said semiconductor laser diode by said photo current generated in said photodiode.

8. A circuit for driving a semiconductor laser diode that emits light by supplying a current, comprising:
a driver transistor connected in parallel to said semiconductor laser diode;
a photodiode for receiving said light emitted from said semiconductor laser diode, said photodiode generating a photo current corresponding to said light received by said photodiode; and
an amplifier for driving said driver transistor,
wherein said amplifier controls said current supplied to said semiconductor laser diode by said photo current generated in said photodiode.
